(19) United States
(12) Patent Application Publication
(10) Pub. No.: US 2025/0293243 A1
(43) Pub. Date: Sep. 18, 2025

(54) COMPOSITE ACTIVE MATERIAL AND BATTERY

(71) Applicant: TOYOTA JIDOSHA KABUSHIKI KAISHA, Toyota-shi (JP)

(72) Inventors: Ryoshi OHTA, Susono-shi (JP); Heidyhodex VISBALMENDOZA, Toyota-shi (JP); Nobuki KYONO, Obu-shi (JP)

(73) Assignee: TOYOTA JIDOSHA KABUSHIKI KAISHA, Toyota-shi (JP)

(21) Appl. No.: 19/034,805

(22) Filed: Jan. 23, 2025

(30) Foreign Application Priority Data
Mar. 18, 2024 (JP) 2024-042726

(51) Int. Cl. H01M 4/36; H01M 4/02; H01M 4/38

(52) U.S. Cl. CPC H01M 4/366; H01M 4/386; H01M 2004/021

(57) ABSTRACT

The composite active material includes an electrode active material including an Si element and having a void therein, and a coating layer covering the surface of the electrode active material and including a solid electrolyte. A composite active material is provided in which BET specific surface area of the composite active material is less than or equal to 40 m²/g, and the coverage by the coating layers is 20% or more.

### CROSS-REFERENCE TO RELATED APPLICATION

This application claims priority to Japanese Patent Application No. 2024-042726 filed on Mar. 18, 2024, incorporated herein by reference in its entirety.

### BACKGROUND

### 1. Technical Field

The present disclosure relates to composite active materials and batteries.

### 2. Description of Related Art

In recent years, batteries have been actively developed. For example, batteries for use in battery electric vehicles (BEVs), plug-in hybrid electric vehicles (PHEVs), or hybrid electric vehicles (HEVs) are being developed in the automotive industry. Members and materials for use in such batteries are also being developed.

For example, Japanese Unexamined Patent Application Publication No. 2023-079684 (JP 2023-079684 A) discloses an anode layer that is used in an all-solid-state battery. This anode layer contains silicon (Si)-based particles having pores as an anode active material.

### SUMMARY

Si has a large theoretical capacity and is effective in increasing energy density of batteries. On the other hand, Si has a large volume change during charging and discharging of a battery. In this regard, it has been considered to use Si-based particles having pores as an electrode active material as in JP 2023-079684 A. However, Si-based particles having pores has an increased specific surface area. In particular, there has been a new issue. Namely, it is difficult to maintain a good interface between the particle surfaces and a solid electrolyte. If a good interface with the solid electrolyte is not maintained, good ion conduction paths may not be maintained and the battery resistance may increase.

The present disclosure was made in view of the above circumstances, and a primary object thereof is to provide a composite active material that can reduce an increase in battery resistance.
(1)

A composite active material includes:
an electrode active material containing an Si element and having a void inside; and
a coating layer covering a surface of the electrode active material and containing a solid electrolyte. A Brunauer-Emmett-Teller (BET) specific surface area of the composite active material is 40 m²/g or less.

A coverage of the composite active material by the coating layer is 20% or more.
(2)

In the composite active material according to (1),
the coverage may be 30% or more.
(3)

In the composite active material according to (1)
the BET specific surface area of the composite active material may be 20 m²/g or more.
(4)

In the composite active material according to (1),
when the coating layer is removed from the composite active material to expose the electrode active material,
the BET specific surface area of the exposed electrode active material may be greater than 40 m²/g.
(5)

A battery includes:
a cathode active material layer;
an anode active material layer; and
a solid electrolyte layer disposed between the cathode active material layer and the anode active material layer.

The anode active material layer contains the composite active material according to any one of (1) to (4).

The present disclosure is advantageous in that it can reduce an increase in battery resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a composite active material in the present disclosure;

FIG. 2 is a schematic sectional view illustrating an electrode active material in the present disclosure;

FIG. 3 is a schematic sectional view illustrating a battery according to the present disclosure;

FIG. 4A is a graph showing the results of examples and comparative examples; and

FIG. 4B is a graph showing the results of the examples and the comparative examples.

### DETAILED DESCRIPTION OF EMBODIMENTS

Hereinafter, the composite active material and the battery according to the present disclosure will be described in detail. Note that the drawings shown below are schematically shown, and the size and shape of each part are appropriately exaggerated for ease of understanding.

### A. Composite Active Material

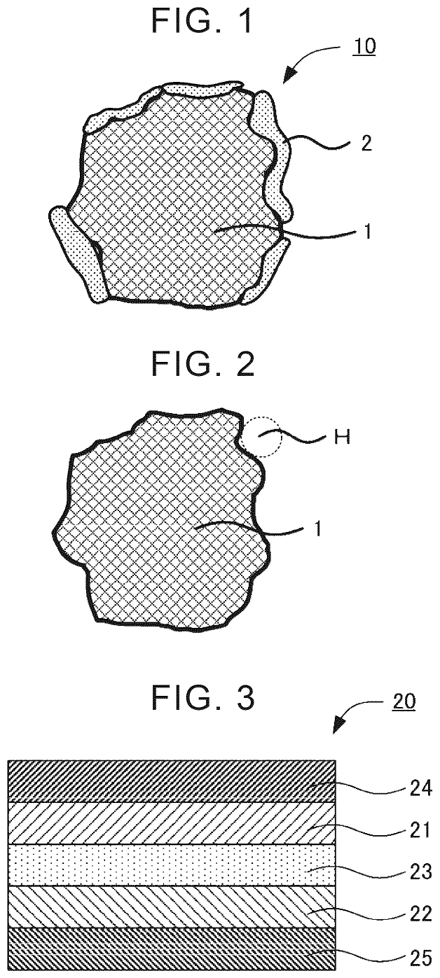

FIG. 1 is a schematic cross-sectional view illustrating a composite active material according to the present disclosure. As will be described later, the electrode active material has a void inside, but the void inside the composite active material 10 (electrode active material 1) shown in FIG. 1 is omitted. The composite active material 10 shown in FIG. 1 includes an electrode active material 1 containing an Si element and having a void (not shown) therein, and a coating layer 2 covering the surface of the electrode active material 1 and including a solid electrolyte. In addition, BET specific surface area of the composite active material 10 is equal to or less than 40 m²/g, and the coverage by the coating layers 2 is equal to or greater than 20%. Here, in the present specification, the electrode active material may be referred to as a porous Si (p-Si), and the composite active material may be referred to as a composite porous Si (composite p-Si).

According to the present disclosure, in the composite active material having the porous Si and the coating layer, BET specific surface area is equal to or less than 40 m²/g, and the coverage is 20% or more.

FIG. 2 is a schematic sectional view illustrating an electrode active material (porous Si). Also in FIG. 2, the internal voids are omitted in the same manner as in FIG. 1. As shown in FIG. 2, fine voids H (depressions and holes) caused by the internal voids are likely to be formed on the surface of the electrode active material 1, and BET specific surface area tends to increase. When such an electrode active material is used, a good interface may not be formed between the solid electrolyte and the electrode active material. In addition, when the electrode active material expands and contracts with charging and discharging of the battery, a good interface with the solid electrolyte may not be maintained. As a result, good ion conduction paths may not be formed and maintained, and battery resistance may increase.

On the other hand, in the composite active material according to the present disclosure, the surface of the porous Si is covered with a coating layer having a solid electrolyte at a coverage of 20% or more, and BET specific surface area is as small as 40 m²/g or less. In other words, it is considered that the fine voids of the above-described porous Si are filled with a solid electrolyte in the composite active material in the present disclosure. As a result, it is considered that a good interface with the solid electrolyte is formed and maintained, and an increase in battery resistance can be suppressed. In addition, since the composite active material has a porous Si, expansion and contraction of Si can be suppressed. As a result, it is considered that cracking of the electrode layer can be prevented, and an increase in battery resistance can be further suppressed.

In the composite active material, BET specific surface area is less than or equal to 40 m²/g. BET specific surface area may be less than or equal to 35 m²/g, less than or equal to 30 m²/g, or less than or equal to 25 m²/g. On the other hand, BET specific surface area may be, for example, 15 m²/g or more, and may be 20 m²/g or more. If BET specific surface area is too small, expansion and contraction (volume change) of Si may not be sufficiently suppressed. BET specific surface area can be calculated by a BET method using a pore-distribution measuring device.

Further, in the composite active material according to the present disclosure, the coverage by the coating layer is 20% or more. The coverage may be 25% or more, or 30% or more. On the other hand, the coverage may be, for example, 85% or less, 80% or less, 70% or less, 60% or less, 50% or less, or 40% or less. If the coverage is too high, BET specific surface area of the composite active material may become too small, and the volume change suppressing effect due to p-Si may not be sufficiently exhibited. The coverage can be calculated by SEM (Scanning Electron Microscopy) observations. More specifically, the methods described in the Examples are included. Details of the coating layer will be described later.

### 1. Electrode Active Material

The electrode active material includes an Si element and has a void inside.

The electrode active material is a so-called Si active material. Examples of Si active material include Si alone, Si and Si oxides. Examples of Si alloy include Si—Al alloys, Si—Sn alloys, Si—In alloys, Si—Ag alloys, Si—Pb alloys, Si—Sb alloys, Si—Bi alloys, Si—Mg alloys, Si—Ca alloys, Si—Ge alloys, and Si—Pb alloys. Si alloy may be a binary alloy or a multicomponent alloy of three or more components. Examples of Si oxide include SiO.

In addition, the electrode active material in the present disclosure has a void inside (particularly, inside the primary particles). The void ratio is, for example, 4% or more, and may be 10% or more. The void ratio may be, for example, 40% or less and 20% or less. The void ratio can be determined, for example, by the following procedure. First, the electrode layer containing the electrode active material is subjected to cross-section extraction by ion milling. Then, the cross section is observed with a SEM (scanning electron-microscope) to obtain a photograph of the grains. The obtained photograph is binarized by using image analysis software to distinguish the silicon portion and the void portion. The area of the silicon portion and the void portion is obtained, and the porosity (%) is calculated from the following equation. When the electrode active material is an Si alloy, the void ratio can be calculated using the area of the silicon-containing portion as the area of the metal-containing portion.

$$Porosity ( \% ) = 100 \times ( void area ) / ( ( silicon area ) + ( void area ) )$$

In addition, in the electrode active material, the void volume of the void having the pore diameter of 50 nm or less is, for example, equal to or greater than 0.05 cc/g and equal to or less than 0.30 cc/g.

Here, when the coating layer is removed from the composite active material to expose the electrode active material, BET specific surface area (also simply referred to as BET specific surface area of the electrode active material) of the exposed electrode active material is usually larger than BET specific surface area of the composite active material. BET specific surface area of the electrode active material is usually larger than 40 m²/g, may be equal to or larger than 42 m²/g, and may be equal to or larger than 45 m²/g. On the other hand, BET specific surface area of the electrode active material is, for example, 100 m²/g or less. BET specific surface area of the electrode active material can be calculated by, for example, a BET method using a pore distribution measuring device with respect to the obtained electrode active material by removing the coating layer from the composite active material by washing with water or the like and drying the obtained electrode active material. When BET specific surface area of the composite active material is X and BET specific surface area of the electrode active material is Y, X/Y is, for example, 0.5 or more, may be 0.6 or more, or may be 0.7 or more. On the other hand, X/Y is, for example, 0.9 or less, and may be 0.8 or less.

The electrode active material may have a diamond-type crystal phase, a clathrate I type crystal phase, or a clathrate II type crystal phase. In a clathrate I or II type crystal phase, a polyhedron (cage) including a pentagon or a hexagon is formed by a plurality of Si elements. This polyhedron has a space in which Li ions can be included, and therefore, a volume change due to charge/discharge can be suppressed.

The shape of the electrode active material is usually particulate. The electrode active material may be primary particles or secondary particles in which primary particles are aggregated. The average particle diameter D₅₀ of the electrode active material is not particularly limited, but may be, for example, 1 nm or more, 10 nm or more, or 100 nm or more. Meanwhile, the average particle diameter D₅₀ of the electrode active material is, for example, 50 μm or less, and may be 20 μm or less. D₅₀ refers to the cumulative 50% particle size in a volume-based particle size distribution by a laser diffractive particle size distribution analyzer.

### 2. Coating Layer

The coating layer in the present disclosure is a layer that covers the electrode active material and contains a solid electrolyte. Further, the coverage by the coating layer is 20% or more. The coverage is as described above.

Examples of the solid electrolyte include an inorganic solid electrolyte such as a sulfide solid electrolyte, an oxide solid electrolyte, a nitride solid electrolyte, a halide solid electrolyte, and a complex hydride. Among these, a sulfide solid electrolyte is particularly preferable. This is because the ion conductivity is high. The sulfide solid electrolyte usually contains sulfur(S) as a main component of an anionic element. The oxide solid electrolyte, the nitride solid electrolyte, and the halide solid electrolyte usually contain oxygen (O), nitrogen (N), and halogen (X) as main components of the anionic element, respectively.

The sulfide solid electrolyte preferably contains, for example, an Li element, an X element (X is at least one of P, As, Sb, Si, Ge, Sn, B, and Al, Ga, In), and an S element. The sulfide solid electrolyte may further contain at least one of an O element and a halogen element.

Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (where m and n are positive numerals, and Z is any one of Ge, Zn, and Ga), Li₂S—GeS₂, Li₂S—SiS₂—Li₃PO₄, Li₂S—SiS₂—LiₓMO_{y} (where x and y are positive numerals, and M is any one of P, Si, Ge, B, Al, Ga, and In).

The sulfide solid electrolyte may be crystalline, amorphous (glass), or crystallized glass (glass-ceramics).

In addition, the coating layer in the present disclosure may contain at least one of a conductive material and a binder. Examples of the conductive material include carbon materials, metal particles, and conductive polymers. Examples of the carbon material include particulate carbon materials such as acetylene black (AB) and Ketjen black (KB), and fibrous carbon materials such as carbon fibers, carbon nanotubes (CNT), and carbon nanofibers (CNF). Examples of the binder include a rubber-based binder and a fluoride-based binder. When the coating layer contains at least one of a conductive material and a binder, the proportion of the solid electrolyte in the coating layer is, for example, 90 wt % or more and 98 wt % or less. On the other hand, the coating layer may not contain the conductive material and the binder.

The thickness of the coating layers is not particularly limited, but may be, for example, 1 nm or more and 100 nm or less, 5 nm or more and 50 nm or less, or 10 nm or more and 30 nm or less. The thickness of the coating layers is determined, for example, as the mean of the thicknesses of a plurality of samples (e.g., 100 or more samples) observed by scanning electron microscopy (SEM) or transmission electron microscopy (TEM).

### 3.Composite Active Material

The composite active material in the present disclosure is usually used in a battery. The composite active material may be used as a cathode active material or an anode active material in a battery, but the latter is preferable. This is because a battery having a higher capacity can be obtained.

The shape of the composite active material is usually particulate. The average particle diameter (D₅₀) of the composite active material is not particularly limited as long as it is larger than the average particle diameter (D₅₀) of the electrode active material, but is, for example, 1 μm or more and 50 μm or less.

The composite active material can be produced by subjecting a mixture containing an electrode active material and a solid electrolyte to compression shear treatment to form the coating layer. Compressive shear treatment includes a method in which the mixture is charged into a container, mixed using a crushing medium such as blades, beads, and balls, to impart compressive shear energy to the mixture present between the mixture and the wall surface of the container.

### B. Battery

FIG. 3 is a schematic cross-sectional view illustrating a battery in the present disclosure. The battery 20 illustrated in FIG. 3 includes a cathode active material layer 21, an anode active material layer 22, a solid electrolyte layer 23, a cathode current collector 24, and an anode current collector 25. The solid electrolyte layer 23 is disposed between the cathode active material layer 21 and the anode active material layer 22. The cathode current collector 24 collects electrons of the cathode active material layer 21. The anode current collector 25 collects electrons of the anode active material layer 22. In particular, in the battery 20 of the present disclosure, the anode active material layers 22 contain the composite active material described in the above-mentioned “A. composite active material”.

According to the present disclosure, since the anode active material layer contains the above-described composite active material, an increase in resistance is suppressed.

### 1. Anode Active Material Layer

The anode active material layer contains the above-described composite active material. The anode active material layer may contain at least one of a conductive material, a binder, and a solid electrolyte, if necessary. The conductive material, the binder, and the solid electrolyte are the same as those described in the “A. composite active material”.

The thickness of the anode active material layer is not particularly limited, but is, for example, 0.1 μm or more and 1000 μm or less. The anode active material layer can be formed by, for example, a coating method. In the coating method, the anode active material layer can be formed by applying a slurry containing at least the composite active material to the anode current collector and drying the slurry.

### 2. Cathode Active Material Layer

The cathode active material layer contains at least a cathode active material. The cathode active material layer may contain at least one of a conductive material, a binder, and a solid electrolyte, if necessary. The conductive material, the binder, and the solid electrolyte are the same as those described in the “A. composite active material”.

Examples of the cathode active material include an oxide active material. Examples of the oxide active material include rock salt-type layered active materials such as LiCoO₂, LiNi_{0.33}Co_{0.33}Mn_{0.33}O₂ and LiNi_{0.8}Co_{0.15}Al_{0.05}O₂, spinel-type active materials such as LiMn₂O₄ and Li₄Ti₅O₁₂, and olivine-type active materials such as LiFePO₄. The shape of the cathode active material is, for example, particulate.

The cathode active material layer can be formed by the coating method described above. The thickness of the cathode active material layer is, for example, 0.1 μm or more and 1000 μm or less.

### 3. Solid Electrolyte Layer

The solid electrolyte layer is a layer disposed between the cathode active material layer and the anode active material layer, and contains at least a solid electrolyte.

Examples of the solid electrolyte include the inorganic solid electrolytes described in “A. composite active material”. Other examples of the solid electrolyte include an organic solid electrolyte such as a polymer electrolyte and a gel electrolyte. The solid electrolyte layer may contain a liquid electrolyte (electrolyte solution) as an electrolyte. The thickness of the solid electrolyte layer is, for example, 1 μm or more and 500 μm or less.

### 4. Other Configurations

The battery according to the present disclosure generally includes a cathode current collector that collects a cathode active material layer and an anode current collector that collects an anode active material layer. Examples of the cathode current collector include SUS, aluminum, nickel, iron, titanium, and carbon. On the other hand, examples of the anode current collector include SUS, copper, nickel, and carbon.

The battery according to the present disclosure may further include a restraining jig that applies a restraining pressure to the cathode active material layer, the solid electrolyte layer, and the anode active material layer along the thickness direction. The constraining pressure is, for example, equal to or higher than 0.1 MPa, may be equal to or higher than 1 MPa, or may be equal to or higher than 5 MPa. On the other hand, the constraining pressure may be, for example, less than or equal to 100 MPa, less than or equal to 50 MPa, or less than or equal to 20 MPa.

### 5. Battery

The type of the battery in the present disclosure is not particularly limited, but is typically a lithium ion battery. Further, since the battery in the present disclosure has a solid electrolyte layer, it typically corresponds to a solid battery. The solid state battery may be a semi-solid state battery or an all-solid state battery. The battery in the present disclosure may be a primary battery or a secondary battery, but is preferably a secondary battery. This is because the battery can be repeatedly charged and discharged, and is useful, for example, as an in-vehicle battery.

Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Further, the battery may be used as a power source for a moving object (for example, a railway, a ship, or an aircraft) other than the vehicle, or may be used as a power source for an electric product such as an information processing apparatus.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### (Preparation of Composite Active Material)

First, an electrode active material (porous Si grains: p-Si) containing an Si element and having a void inside was prepared in the following manner.

Particles (27.7 g) of Si alone were milled by a ball mill to adjust the particle size. The ball mill was 1000 rpm and 3 h. The crushed Si single grains and metallic Li (32.5 g) were then added to a mortar and mixed at room temperature to obtain an alloyed LiSi. The mortar mixing was performed by 50 rpm and 20 min. Then, 600 ml added LiSi to mesitylene solvent (600 ml), while stirring at room temperature and 250 rpm, 0° C. or less of ethanol at a constant rate (1 drop/5 sec) was added dropwise. In addition, acetic acid was added dropwise 800 ml while stirring with 250 rpm. The resulting solution was filtered under reduced pressure to recover the powder. The collected powder was dried in vacuo (−0.1 MPa, 12 h) to remove solvents. Thereafter, further thermal drying (160° C., 12 h) was performed. As a result, porous Si grains were obtained.

The resulting porous Si grains were mixed with a sulfide solid electrolyte (LiI—Li₂S—P₂S₅; glass ceramics) in a volume ratio of 100:81.8. The resulting mixture was mixed with a planetary mixer (2-axis planetary kneader) while applying a shear force. As a result, a composite active material (composite p-Si) in which a layer (coating layer) of a sulfide solid electrolyte was formed on the surface of the electrode active material was obtained. Using the composite active material as an anode active material, an evaluation battery (all-solid-state battery) was produced as described later. (Preparation of Evaluation Battery)

Further, a conductive material (carbon nanotube), a binder (styrene-butadiene rubber: SBR), and a dispersing medium (diisobutyl ketone) were added to the composite active material and the sulfide solid electrolyte, and mixed to obtain an anode slurry. In the anode slurry, the ratio of the composite active material, the sulfide solid electrolyte, the binder, and the conductive material was set to a weight ratio of 52.93:44.11:1.49:0.26. The anode slurry was applied to an anode current collector (Cu foil) and dried to obtain an anode having anode active material layers and an anode current collector.

In addition, a cathode slurry was obtained by mixing a cathode active material (LiNi_{0.8}Co_{0.15}Al_{0.05}O₂), a sulfide solid electrolyte (LiI—Li₂S—P₂S₅; glass ceramics), a binder (styrene-butadiene rubber: SBR), a conductive material (carbon nanotubes), and a dispersing medium (1,2,3,4-tetrahydronaphthalene). In the cathode slurry, the ratio of the composite active material, the sulfide solid electrolyte, the binder, and the conductive material was set to a weight ratio of 82.04:15.65:0.34:1.97. The cathode slurry was applied to a cathode current collector (Al foil) and dried to obtain a cathode having cathode active material layers and a cathode current collector. The cathode size was adjusted to be smaller than the anode size.

Further, a sulfide solid electrolyte (LiI—Li₂S—P₂S₅; glass-ceramic), a binder (acrylate-butadiene rubber: ABR), and a dispersing medium (n-heptane, butyl butyrate) were mixed to obtain a slurry. The slurry was applied to a substrate (Al foil) and dried to obtain a transfer member having a solid electrolyte layer. The size of the solid electrolyte layer was the same as that of the anode.

The anode and the transfer member were stacked and pressed so that the anode active material layer and the solid electrolyte layer were opposed to each other. Thereafter, the substrate was peeled off to transfer the solid electrolyte layer. Further, the cathode was stacked and pressed so that the solid electrolyte layer and the cathode active material layer were opposed to each other. The terminals were then mounted and constrained to 5 MPa pressure-to-electrode area. As a result, an evaluation battery (all-solid-state battery) was obtained.

### Examples 2 to 3

Evaluation batteries were prepared in the same manner as in Example 1, except that a composite p-Si was prepared by changing the ratio of the porous Si grains and the sulfide solid electrolyte so as to obtain a predetermined coverage ratio.

### Comparative Example

Porous Si grains were prepared in the same manner as in Example-1. Evaluation batteries were prepared in the same manner as in Example 1, except that porous Si grains were used as the anode active material.

### [Evaluation]

### (Observation of SEM and Measuring of Coverage)

Surface SEM images were obtained for the anode active materials of Examples 1 to 3 and Comparative Examples. Further, for Examples 1 to 3, the coverage was calculated as follows. The results are shown in Table 1. First, from the obtained SEM images, binarized images of the portions covered with the coating layers and the portions not covered were prepared. The binarized image was created using image analysis software “ImageJ”. Then, the area of the covered portion and the area of the uncoated portion in the image were determined by image analysis software. Using these values, the coverage was calculated by the following formula.

$$Coverage ( \% ) = ( ( Surface of coating portion ( {µm}^{2} ) ) / ( Area of coating portion + uncoated portion ( {µm}^{2} ) ) \times 100$$

### Measuring BET Specific Surface Area

For the anode active materials of Examples 1 to 3 and Comparative Examples, BET specific surface area was calculated from BET method using a pore-distribution measuring device. The results are shown in Table 1. In Examples 1 to 3, since the coating is applied to the same p-Si as in the comparative example, the coverage of the comparative example can be regarded as the specific surface area before the coating of the anode active materials of Examples 1 to 3.

### Cycle Test!

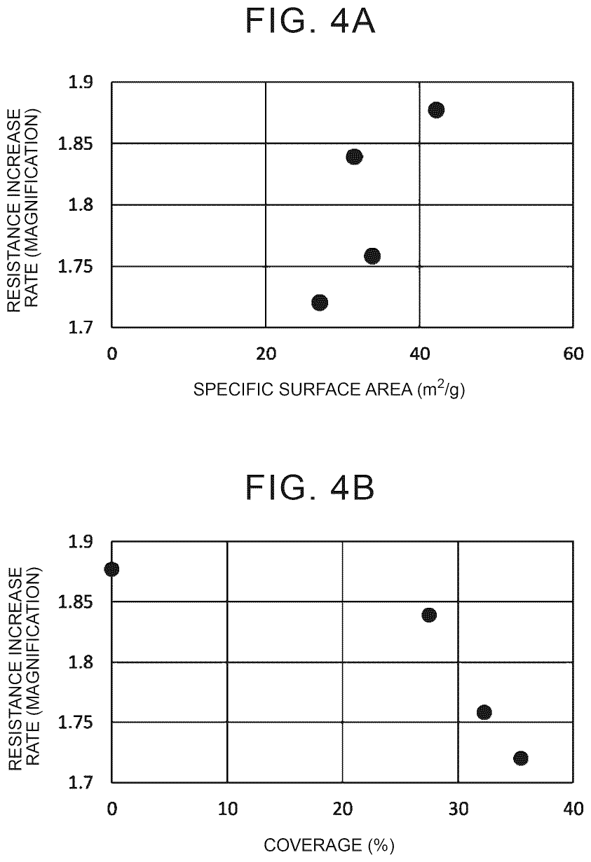

Evaluation batteries obtained in Examples 1 to 3 and Comparative Examples were CCCV charged with 1/3 C at 25° C. to 4.05 V and then CCCV discharged with 1/3 C at 2.5 V at 25° C. to activate. Cycling tests were carried out on the activated cell under the conditions of 2.5 V to 4.05 V, 60° C. and 1/3 C. From the resistance values before and after the cycle test, the resistance increase rate (increase rate of the resistance value after the cycle test with respect to the resistance value before the cycle test) was calculated. For the resistance, the 5 second discharging resistance for the cell adjusted to SOC50% was measured. Specifically, the voltage change AV value when the current value of 6 C rate was passed at 25° C. was read, and the resistance value was calculated by Ohm's law (V=IR). The results are shown in Table 1. The specific surface area and the resistivity increase rate are shown in FIG. 4A, and the relation between the coverage and the resistivity increase rate is shown in FIG. 4B. In FIG. 4B, the coverage of the comparative example was set to 0%.

TABLE 1

| | Negative | | Non-surface | Resistance |
|---|---|---|---|---|
| | active | Coverage | area | increase |
| | material | (%) | (m²/g) | (Magnification) |
| Comparative | p-Si | — | 42.19 | 1.877 |
| Example | | | | |
| Example 1 | Combined p-Si | 35.44 | 27.09 | 1.720 |
| Example 2 | Combined p-Si | 27.49 | 31.60 | 1.839 |
| Example 3 | Combined p-Si | 32.26 | 33.90 | 1.758 |

From SEM images, it was confirmed that fine voids were formed on the surface of p-Si in the comparative example. On the other hand, it was confirmed that the solid electrolyte was disposed on the surface of the composite p-Si in Examples 1 to 3, and the surface was smooth. In addition, as shown in Table 1, it was confirmed that the specific surface area of each of the examples was smaller than that before coating (42.19 m²/g) by coating the solid electrolyte. Here, as shown in FIGS. 4A and 4B and Table 1, although the coverage of Example 3 was larger than that of Example 2, the specific surface area was smaller in Example 2. Although the reason is not clear, in Example 3, since the void size of the surface is smaller than that in Example 2, it is presumed that the solid electrolyte did not sufficiently fill the voids of the surface of p-Si, although the coverage ratio is large.

As shown in Tables 1 and FIGS. 4A, 4B, it was confirmed that in Examples 1 to 3, the resistance increase rate of the battery was suppressed as compared with the comparative example, and the composite active material according to the present disclosure was able to suppress the increase in the battery resistance.

What is claimed is:

1. A composite active material, comprising:
an electrode active material containing a silicon element and having a void inside; and
a coating layer covering a surface of the electrode active material and containing a solid electrolyte, wherein
a Brunauer-Emmett-Teller specific surface area of the composite active material is 40 m²/g or less, and
a coverage of the composite active material by the coating layer is 20% or more.

2. The composite active material according to claim 1, wherein the coverage is 30% or more.

3. The composite active material according to claim 1, wherein the Brunauer-Emmett-Teller specific surface area of the composite active material is 20 m²/g or more.

4. The composite active material according to claim 1, wherein when the coating layer is removed from the composite active material to expose the electrode active material, the Brunauer-Emmett-Teller specific surface area of the exposed electrode active material is greater than 40 m²/g.

5. A battery, comprising:
a cathode active material layer;
an anode active material layer; and
a solid electrolyte layer disposed between the cathode active material layer and the anode active material layer, wherein the anode active material layer contains the composite active material according to claim 1.
